(19) United States
(12) Patent Application Publication
(10) Pub. No.: US 2012/0014309 A1
(43) Pub. Date: Jan. 19, 2012

(54) WIRELESS COMMUNICATION APPARATUS, WIRELESS NETWORK SYSTEM, DATA TRANSFER METHOD, AND RECORDING MEDIUM

(76) Inventors: Hiroyuki Iizuka, Tokyo (JP); Yuichiro Ezure, Tokyo (JP); Yoshiaki Takakura, Tokyo (JP); Tetsuya Ito, Tokyo (JP); Yuki Kumagai, Chiba (JP); Yasuhiro ` Goto, Chiba (JP); Shiro Sakata, Chiba (JP)

(21) Appl. No.: 13/138,707

(22) PCT Filed: Mar. 15, 2010
(86) PCT No.: PCT/JP2010/054295

§ 371 Date: Sep. 21, 2011

(30) Foreign Application Priority Data
Mar. 23, 2009 (JP) 2009-071048

(51) Int. Cl. H04W 4/06

(52) U.S. Cl. 370/312

(57) ABSTRACT

A WMMR (301) is used as a wireless relay node in a wireless network connected to a backbone network including a multicast data packet distribution source. A route control unit (N03) establishes a multicast data packet transfer route based on unicast routes by making reference to an SWGT (20) based on received route control information and adding an entry to a multicast routing table (MRT) (10). A transfer control unit (N04) makes reference to the MRT (10) and makes a transfer to a directly connected transfer destination along the established multicast data packet transfer route by unicasting capable arrival confirmation and retransmission control as a transmission scheme in the data link layer.

### TECHNICAL FIELD

The present invention relates to a wireless communication apparatus, wireless network system, data transfer method, and recording medium for transferring multicast data packets.

### BACKGROUND ART

Technology for distributing digitalized sound and video images on a wired or wireless IP (Internet Protocol) network has drawn attention (for example, see Patent Literature 1 to 4). Distribution on an IP network is effectively done through one-to-many communication by IP multicast. Such distribution technology is about to be realized by recent broadband and high quality core networks.

In IP multicast transmission, generally, broadcast communication is performed in the data link layer and UDPs (User Datagram Protocols) are used in the transport layer. Broadcasting is incapable of arrival confirmation in the data link layer; therefore, packet loss leads to missing data at the application level. This also applies to a wireless network such as a wireless multihop network.

Recently, among wireless networks, for example, wireless mesh networks in which wireless links are connected at multiple levels have become in widespread use. Such wireless networks often undergo flickering in radio waves, fading, and bit errors due to radio wave interference compared with wired networks. Therefore, packet loss occurring in the physical layer directly leads to missing data at the application level.

Furthermore, for realizing IP multicast broadcast and advertisement distribution, it is necessary to have capability of multicasting data sent from an external network. When a backbone network and a wireless multihop network are connected, a multicast transmission source is present in the backbone network, and a receiving terminal is present in the wireless multihop network, the receiving terminal is not directly connected to the LHR (Last Hop Router). In such a case, an existing IGMP (Internet Group Management Protocol)-Proxying technique (see Non-Patent Literature 1) is used to send an IGMP packet to the LHR to establish a multicast data packet transfer route, whereby multicast data packets can be received.

### PRIOR ART DOCUMENTS

### Patent Literatures

Patent Literature 1: Unexamined Japanese Patent Application KOKAI Publication No. 2007-129779;

Patent Literature 2: Unexamined Japanese Patent Application KOKAI Publication No. 2007-49382;

Patent Literature 3: Unexamined Japanese Patent Application KOKAI Publication No. 2007-53486; and

Patent Literature 4: Unexamined Japanese Patent Application KOKAI Publication No. 2002-281030.

### NON-PATENT LITERATURES

Non-Patent Literature 1: IGMP-Proxying: Internet Group Management Protocol (IGMP) / Multicast Listener Discovery (MLD)-Based Multicast Forwarding (“IGMP/MLD Proxying”), RFC 4605.

### SUMMARY OF INVENTION

### Problems to be Solved by the Invention

Multicast transmission in related wireless networks has the following problems.

(1) A wireless network such as a wireless mesh network often undergoes flickering in radio waves, fading, and bit errors due to radio wave interference and accordingly has frequent packet loss. In current multicast transmission, broadcasting is performed in the data link layer and UDP protocols are used in the transport layer. There is no data packet arrival confirmation and, therefore, the data packet distribution rate cannot be improved.

Furthermore, a wireless mesh network has problems such as packet loss due to hidden terminals and reduced throughput due to exposed terminals. The system described in the above Patent Literature 1 does not address these problems and may undergo packet loss and reduced throughput.

(2) Because of communication with multiple unspecific nodes, broadcasting in the data link layer is data transmission at the lowest transfer rate. Accordingly, the broadcasting occupies the communication band for a prolonged time, hampering high speed multicast transmission. Consequently, another unicast communication using the same channel at the same time is subject to pressure on the band and undergoes reduced throughput.

(3) IGMP-Proxying techniques are not invented in consideration of wireless multihop networks. The physical ports connected upstream (on the side to the sender) and downstream (on the side to the recipient) of a multicast flow have to have fixed settings. Therefore, it is difficult to receive a multicast data packet from any interface and make a transfer to a proper interface dynamically.

The present invention is invented in view of the above circumstances and an exemplary object of the present invention is to provide a wireless communication apparatus, wireless network system, data transfer method, and recording medium with which the multicast data packet distribution rate can be improved.

### MEANS FOR SOLVING THE PROBLEM

In order to achieve the above object, the wireless communication apparatus according to a first exemplary aspect of the present invention is:

a wireless communication apparatus used as a wireless relay node in a wireless network connected to a backbone network including a multicast data packet distribution source, comprising:

a route control unit establishing a multicast data packet transfer route connecting the distribution source and a receiving terminal based on unicast routes; and

a transfer control unit making a transfer to a directly connected transfer destination along the established multicast data packet transfer route by unicasting capable of arrival confirmation and retransmission control as a transmission scheme in the data link layer.

The wireless network system according to a second exemplary aspect of the present invention has the wireless communication apparatus according to the present invention as a wireless relay node.

The date transfer method apparatus according to a third exemplary aspect of the present invention is:

a data transfer method for a wireless relay node in a wireless network connected to a backbone network including a multicast data packet distribution source, comprising:

a route control step of establishing a multicast data packet transfer route connecting the distribution source and a receiving terminal based on unicast routes; and

a transfer control step of making a transfer to a directly connected transfer destination along the established multicast data packet transfer route by unicasting capable of arrival confirmation and retransmission control as a transmission scheme in the data link layer.

The computer-readable recording medium on which programs are recorded according to a fourth exemplary aspect of the present invention is:

a computer-readable recording medium on which recorded are programs used for controlling a wireless relay node in a wireless network connected to a backbone network including a multicast data packet distribution source, wherein the programs allow a computer to execute:

a route control procedure to establish a multicast data packet transfer route connecting the distribution source and a receiving terminal based on unicast routes; and

a transfer control procedure to make a transfer to a directly connected transfer destination along the established multicast data packet transfer route by unicasting capable of arrival confirmation and retransmission control as a transmission scheme in the data link layer.

### EFFECT OF THE INVENTION

According to the present invention, a multicast data packet is sent by unicasting capable of arrival confirmation and retransmission control. Consequently, the multicast data packet distribution rate can be improved.

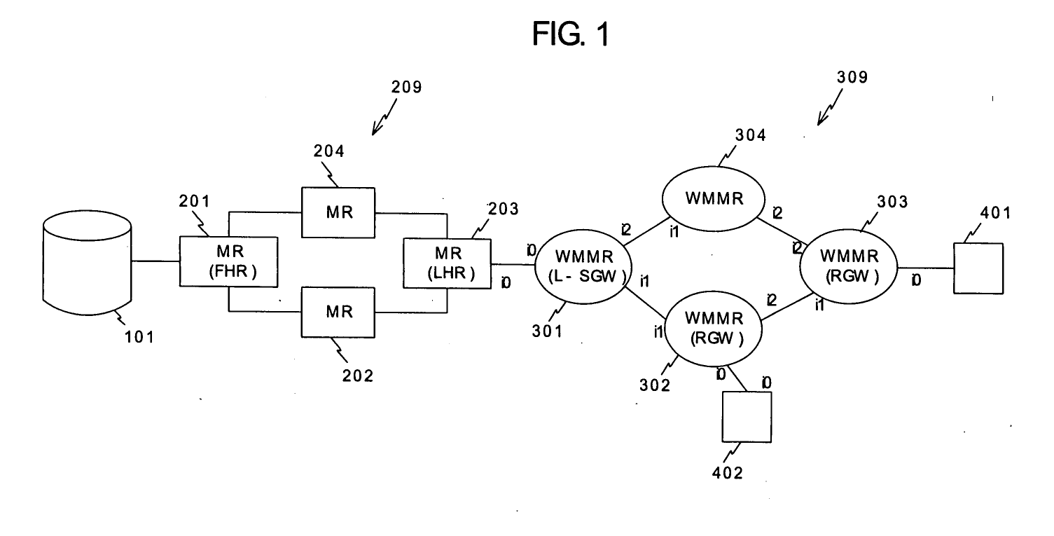

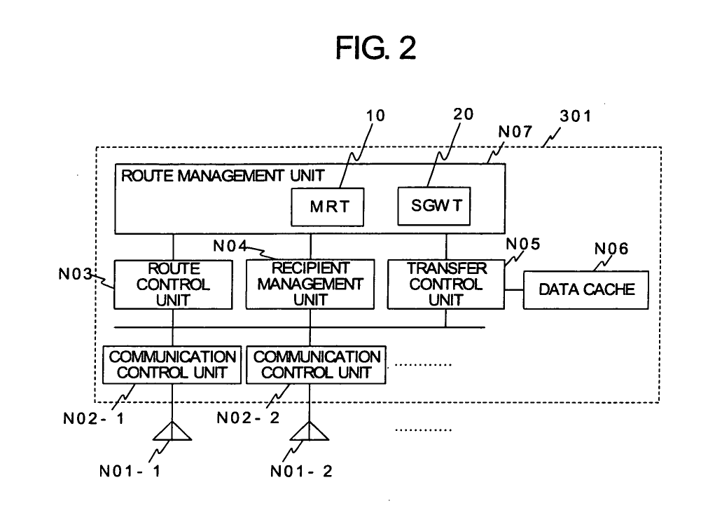

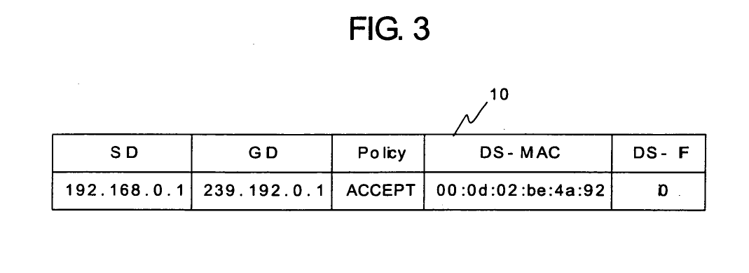

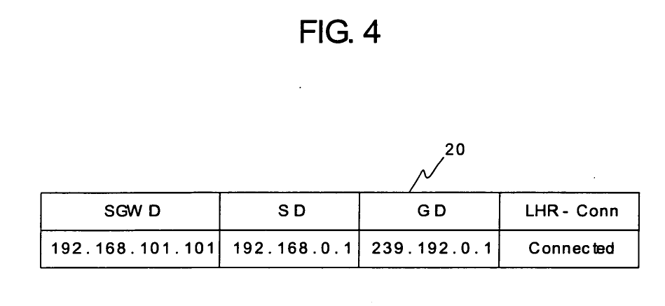

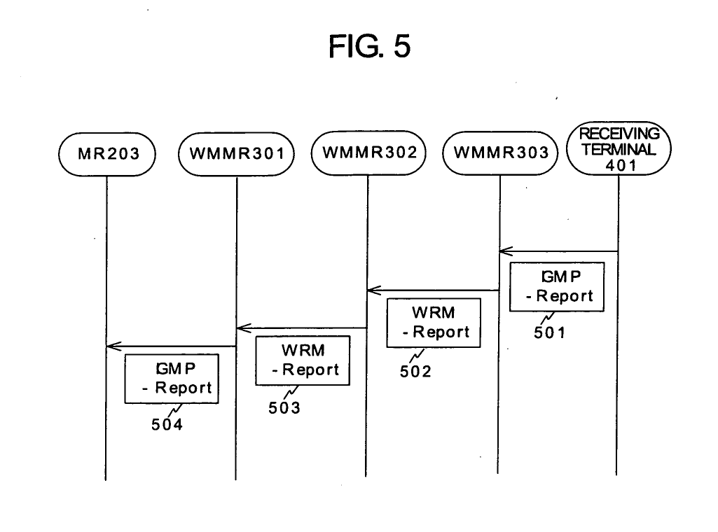

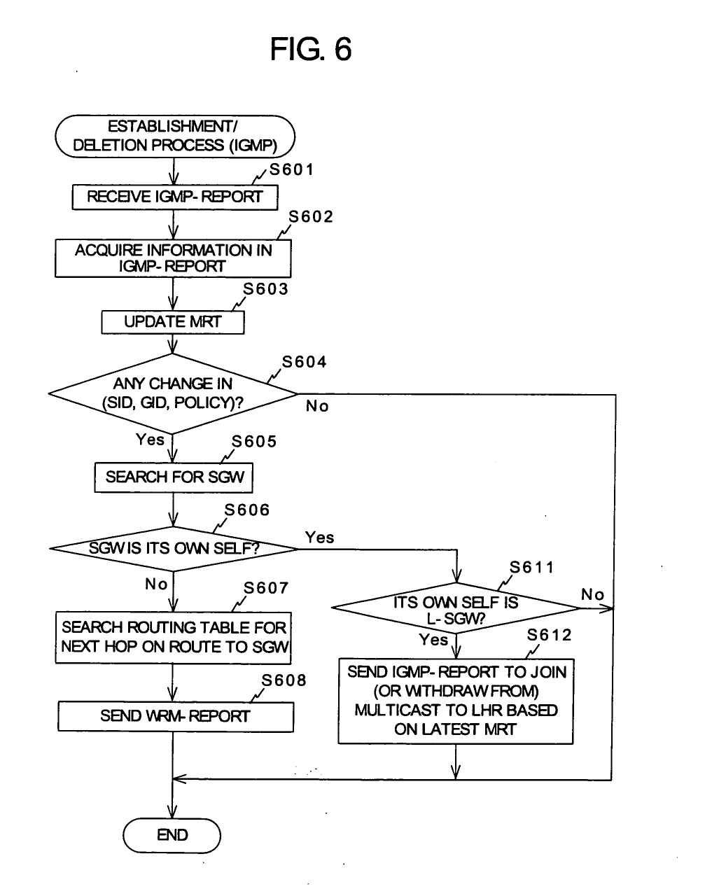

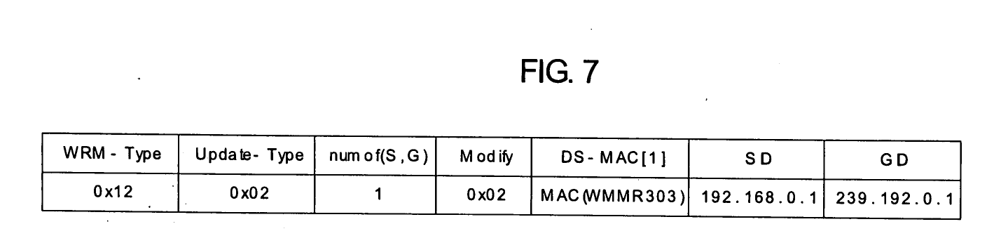

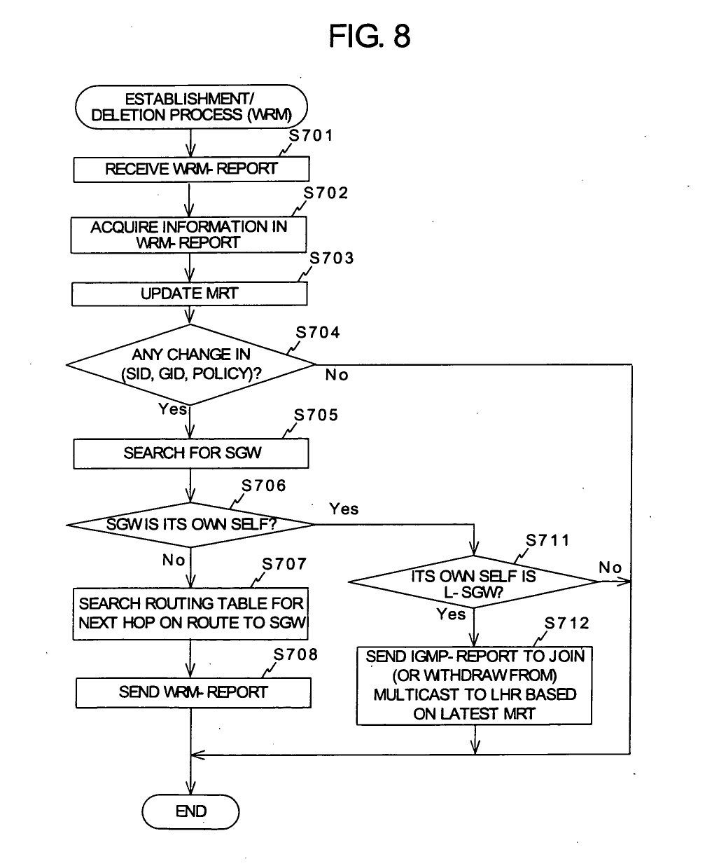

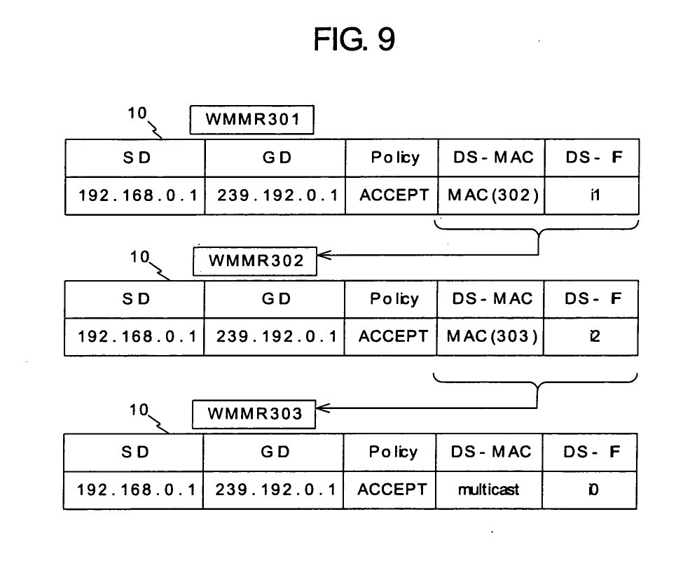

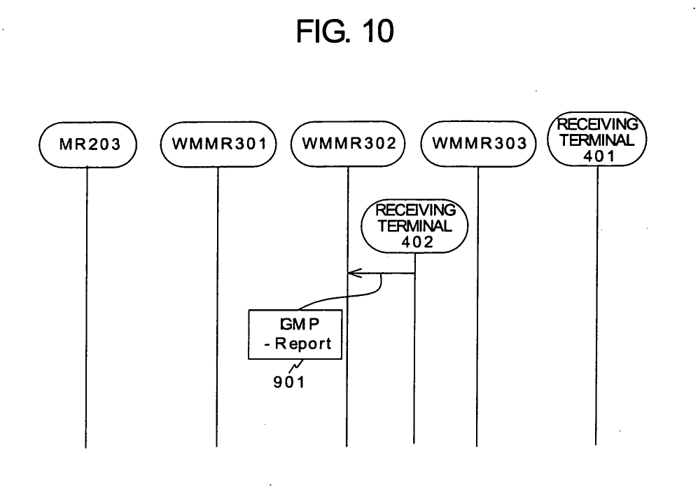

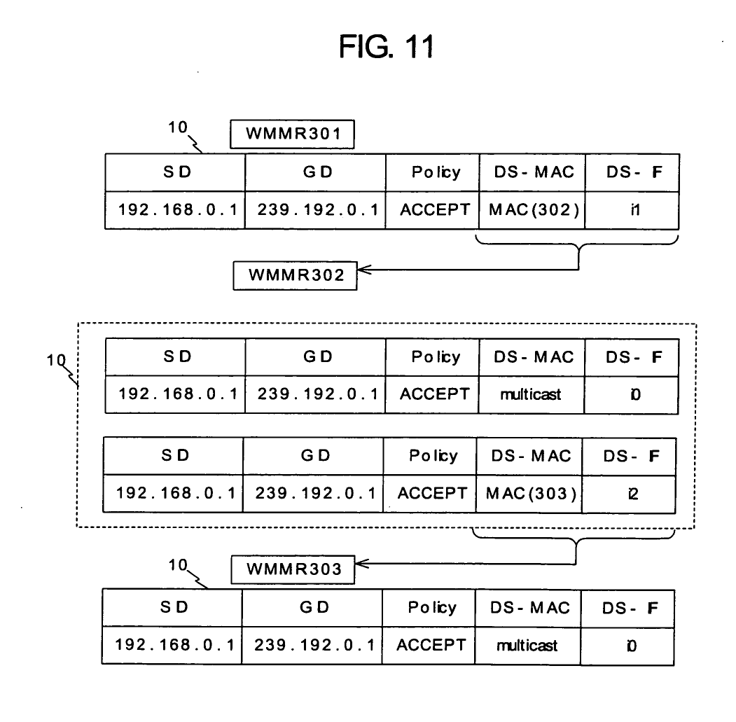

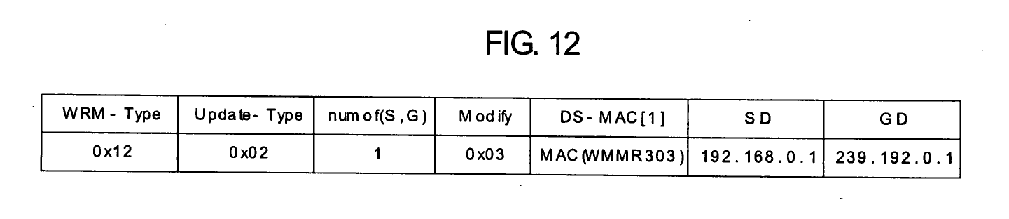

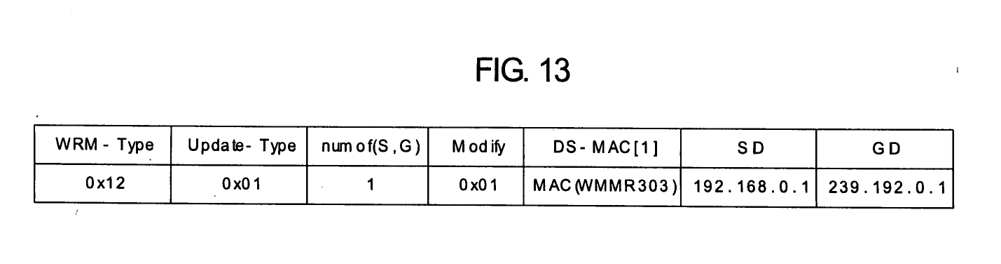

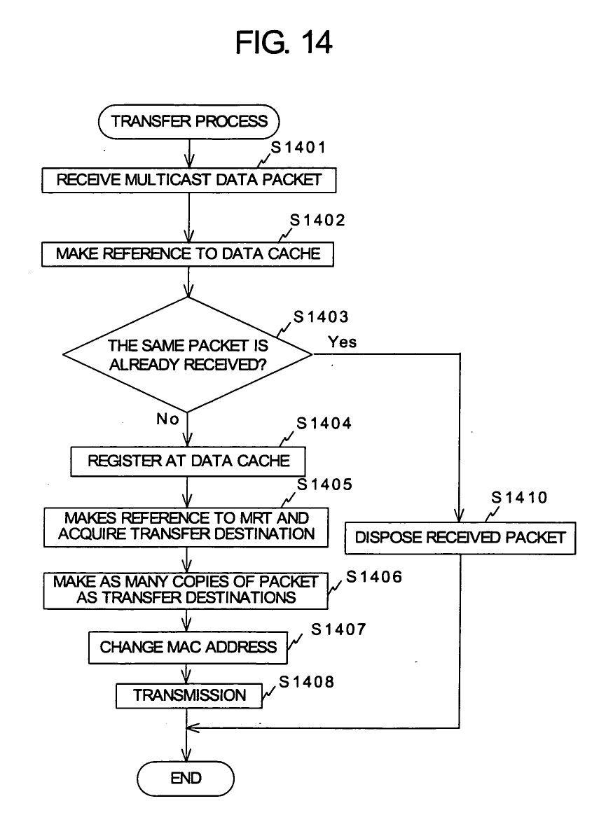

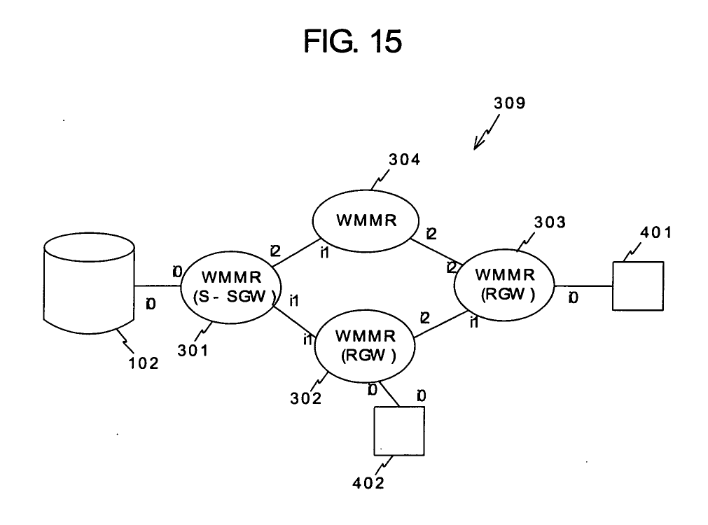

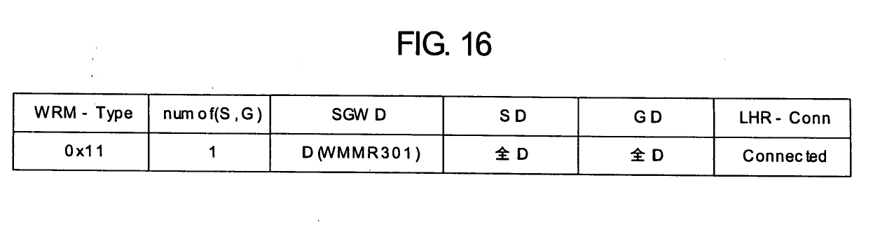

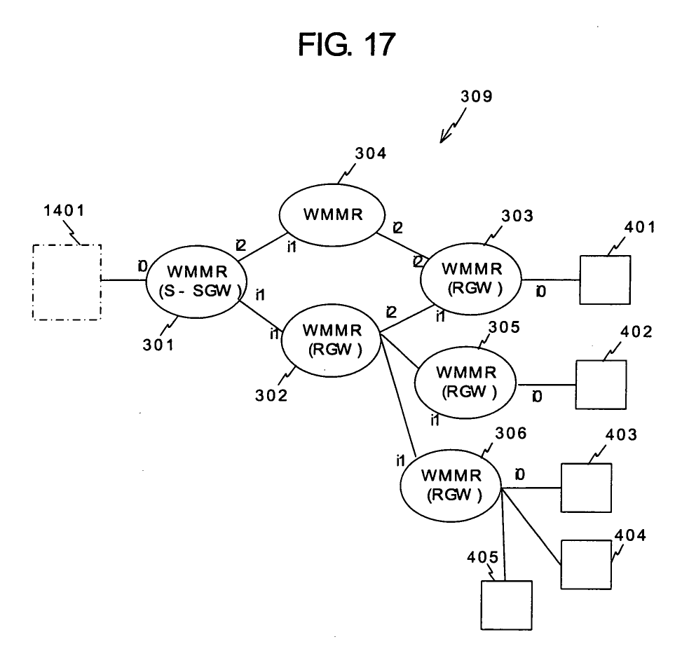

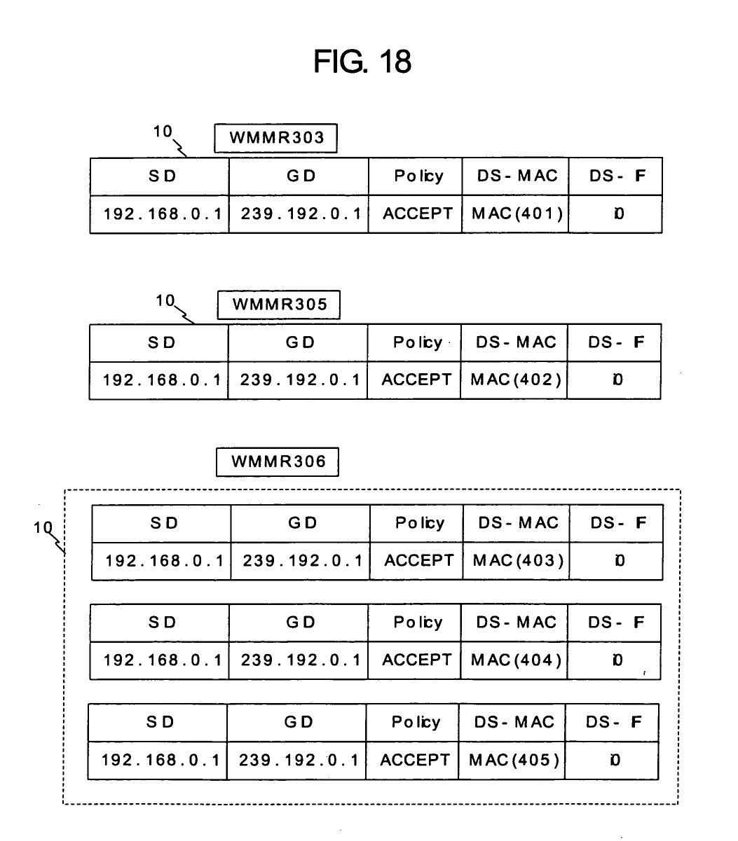

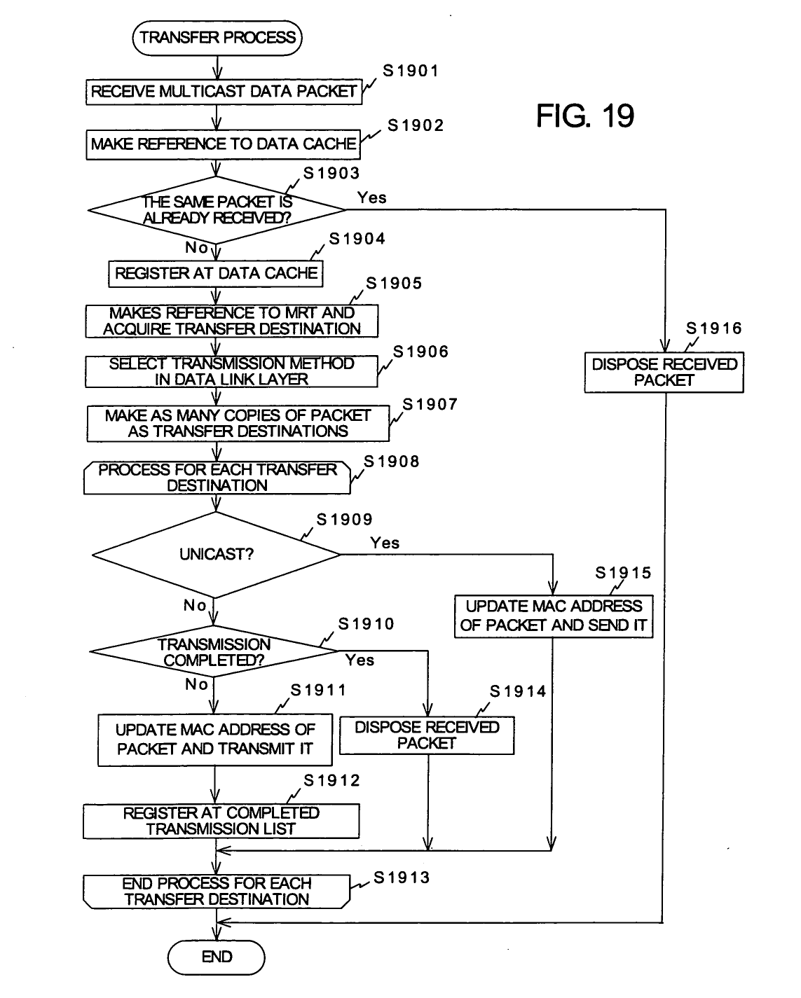

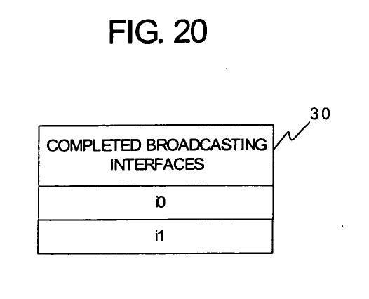

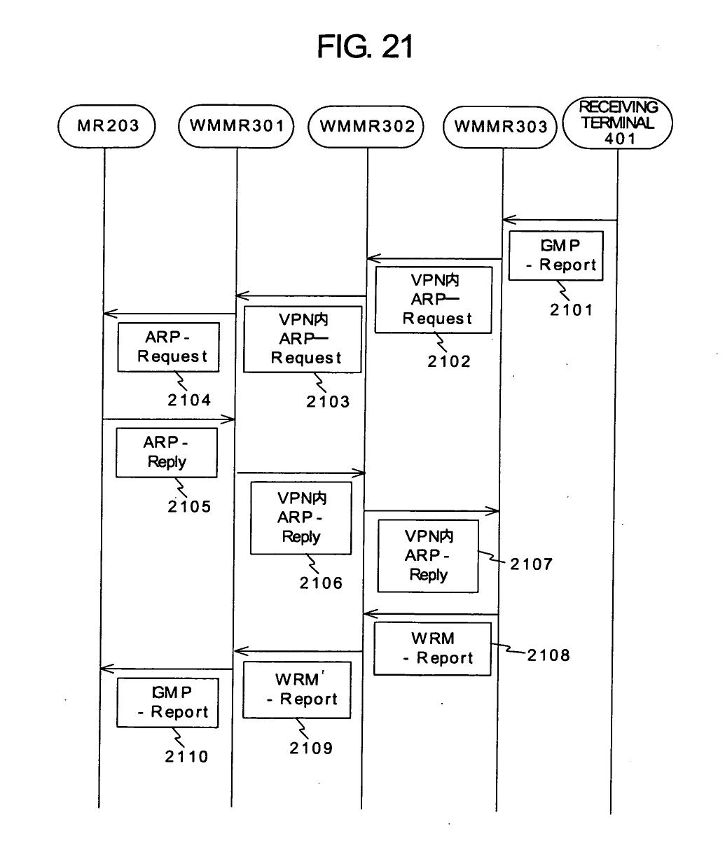

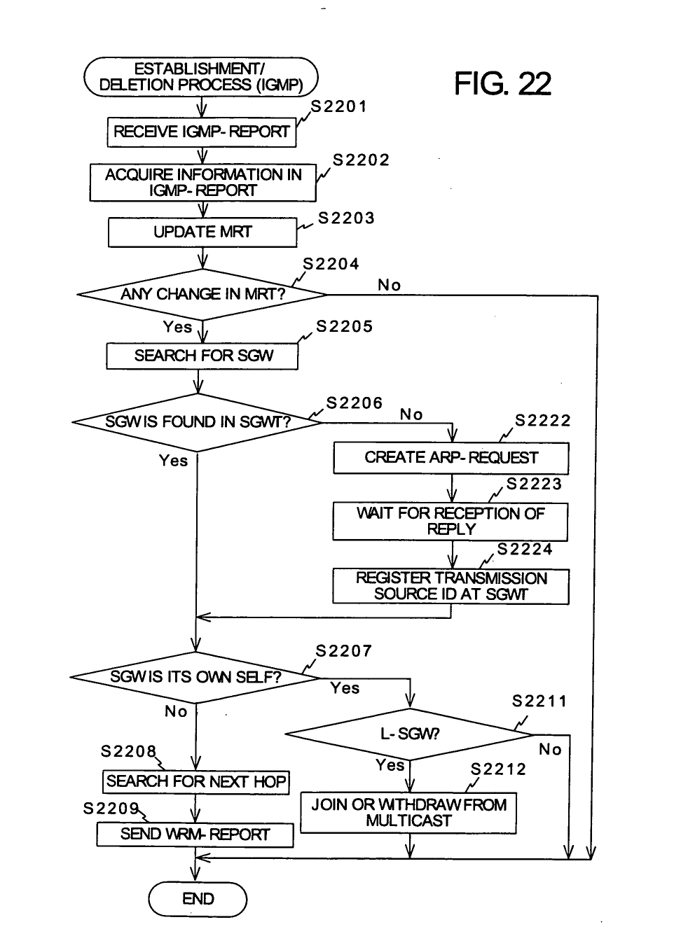

### BRIEF DESCRIPTION OF DRAWINGS

[FIG. 1] An illustration showing the node allocation of a wireless network system according to Embodiment 1 of the present invention;

[FIG. 2] A block diagram showing the configuration of a wireless multihop multicast router;

[FIG. 3] An illustration showing the management information (entry) of a multicast routing table;

[FIG. 4] An illustration showing the management information (entry) of a source gateway table;

[FIG. 5] A chart showing the transfer sequence of route control packets for establishing/deleting a multicast data transfer route;

[FIG. 6] A process flowchart of a WMMR upon receiving an IGMP-Report;

[FIG. 7] An illustration showing the data format of a WRM-Report;

[FIG. 8] A process flowchart of a WMMR upon receiving a WRM-Report;

[FIG. 9] An illustration showing the registered entries of the multicast routing tables of the WMMRs;

[FIG. 10] A chart showing the transfer sequence of a route control packet for additionally registering/deleting a receiving terminal;

[FIG. 11] An illustration showing the entries of the multicast routing tables of the WMMRs after additional registration;

[FIG. 12] An illustration showing the packet fields of a WRM-Report for deleting the entry;

[FIG. 13] An illustration showing the packet fields of a WRM-Report for maintaining the entry;

[FIG. 14] A process flowchart of the multicast data packet transfer operation;

[FIG. 15] An illustration showing the node allocation of a network system configuration according to Embodiment 2 of the present invention;

[FIG. 16] An illustration showing the packet fields of a WRM-SGWAD packet;

[FIG. 17] An illustration showing the node allocation of a network system configuration according to Embodiment 4of the present invention;

[FIG. 18] An illustration showing the registered entries of the multicast routing tables of WMMRs in the network of FIG. 17;

[FIG. 19] A process flowchart of the multicast data packet transfer operation in the network system of FIG. 17;

[FIG. 20] A completed broadcasting list;

[FIG. 21] An illustration showing the transfer sequence of route control packets when a VPN network is formed; and

[FIG. 22] A process flowchart of a WMMR upon receiving a WRM-Report when a VPN network is formed.

### BEST MODE FOR CARRYING OUT THE INVENTION

Embodiments of the present invention will be described in detail hereafter with reference to the drawings.

### Embodiment 1

First, Embodiment 1 of the present invention will be described. FIG. 1 is an illustration showing the node allocation of a wireless network system according to Embodiment 1. As shown in FIG. 1, a wireless multihop network 309 as a wireless network system according to Embodiment 1 of the present invention is connected to a backbone multicast network 209.

Here, a “backbone multicast network” is a multicast network established by a known 25 multicast route establishing method. Examples of such a multicast route establishing method include methods using a multicast routing protocol such as PIM-SM and DVMR as described in the following literature.

(1) PIM-SM: Protocol Independent Multicast-Sparse Mode (PIM-SM): Protocol Specification (Revised), RFC 4601

(2) DVMRP: Distance Vector Multicast Routing Protocol, RFC 1075.

The backbone multicast network 209 is configured by connecting multicast routers (“MR” hereafter) 201 to 204. A server 101 is connected to the backbone multicast network 209. The MR connected to the server 101 is termed FHR (First Hop Router). In this embodiment, the server 101 is the distribution source of multicast data packets.

The wireless multihop network 309 is configured by wireless multihop multicast routers (“WMMR” hereafter) 301 to 304. A receiving terminal 401 receiving multicast data packets at the end is connected to the WMMR 303. A receiving terminal 402 receiving multicast data packets at the end is connected to the WMMR 302.

The receiving terminals 401 and 402 have already acquired the IP address of the server 101 or the multicast content distribution source and a multicast group D. They can acquire those by SDP session description and notification in SAP or other protocol or by a method specific to a multicast application.

(3) SDP: Session Description Protocol, RFC 4566.

(4) SAP: Session Announcement Protocol, RFC 2974.

Among the WMMRs 301 to 304, those that are connected to an external network or a multicast distribution source and transfer received packets to another wireless multihop network are termed SGW (Source GateWay). Among the SGWs, those connected to an external network are termed L-SGW (LHR-connected SGW) and those connected to a multicast distribution source are termed S-SGW (Source-connected SGW). Among the WMMRs, those connected to a receiving terminal are termed RGWs (Receiver GateWays). In this embodiment, the WMMR 301 is an L-SGW. An MR connected to the WMMR 301 is termed an LHR (last hop router). The WMMRs 302 and 303 are RGWs.

A unicast routing table (not shown) is established in a wireless mesh network. An unicast routing table is established by, for example, an OLSR or AODV technique described in the literature below. Some of these protocols provide extension in consideration of link quality and traffic control. Such extension is also effective in the multicast route establishing method shown in this embodiment.

(5) OLSR: Optimized Link State Routing Protocol (OLSR), RFC 3626.

(6) AODV: Ad hoc On-Demand Distance Vector (AODV) Routing, RFC 3561.

FIG. 2 is a block diagram showing the configuration of a wireless multihop multicast router. As shown in FIG. 2, the WMMR 301 comprises physical interfaces N01-1, N01-2, . . . , communication control units N02-1 and N02-2, a route control unit N03, a recipient management unit N04, a transfer control unit N05, a data cache N06, and a route management unit N07.

The physical interfaces N01-1, N01-2, ... transmit/receive signals to/from communication media used for communication. The communication control units N02-1, N02-2, . . . control transmission/reception of route control data packets and data packets (including multicast data packets).

At least one physical interfaces and at least one communication control unit are provided. When an MIMO (Multiple Input Multiple Output) technique is installed, multiple wireless control units may be provided for one physical interface. The physical interface has a proper function according to the communication medium type. For example, it includes an antenna for a wireless communication medium such as a wireless LAN or includes a contact to change the voltage for a wired communication medium such as a wired LAN.

The physical interfaces N01-1, . . . and communication control units N02-1, . . . form interfaces i0, i2, . . . of the WMMR. FIG. 1 shows interfaces i0, i1, and i2 of the WMMRs 301 to 304. For example, the interfaces i0, i1, and i2 of the WMMR 301 are connected to the interface i0 of the MR 203, the interface i1 of the WMMR 302, and the interface i1 of the WMMR 304. The physical interfaces i0 and i2 of the WMMR 302 are connected to the interface i0 of the receiving terminal 402 and the interface i1 of the WMMR 303. The interfaces i0 and i2 of the WMMR 303 are connected to the interface i0 of the receiving terminal 401 and the interface i2 of the WMMR 304.

The route control unit N03 establishes a multicast data packet transfer route based on the contents of route control packets. The recipient management unit N04 receives route control packets sent from the receiving terminals 401 and 402. The transfer control unit N05 transfers multicast data packets. The data cache N06 temporarily stores the multicast data packets. The route management unit N07 has management tables such as a multicast routing table 10 and a source gateway table 20 and manages the transfer routes of multicast data packets based on these management tables.

In the following explanation, a “node ID” or “ID” is an identifier by which a wireless relay node can uniquely be identified in a wireless multihop network. The ID can be, for example, an IP address.

The route management unit N07 of the WMMRs 301 to 304 manages the following information.

(A) A multicast routing table (“MRT, hereafter) 10; and

(B) A source gateway table (“SGWT” hereafter) 20:

FIG. 3 is an illustration showing the management information (entry) of a multicast routing table. As shown in FIG. 3, the MRT 10 has an entry form (SID, GID, Policy, DS-MAC, and DS-IF).

Here, the SID is a data packet distribution source ID. In the network configuration of FIG. 1, the IP address of the server 101 is registered. Besides a data packet distribution source, “All ID” denoting all IDs can be registered in the SD.

The GID is a multicast group ID. The SID and GID define a multicast group having the SID as the distribution source.

The Policy is a value indicating whether transfer is available. In the Policy, “ACCEPT” is registered when transfer is available and “DROP” is registered when transfer is unavailable.

The DS-MAC is the MAC address of a transfer destination node. The WMMR 301 transfers multicast data packets to this MAC address. The DS-IF is an interface to which the transfer destination node is connected. The WMMR 301 transfers multicast data packets via this interface.

For example, the MRT 10 of the WMMR 301 has the entry shown in FIG. 3 in which SID is “192.168.0.1”; GID is “239.192.0.1”; Policy is “ACCEPT”; DS-MAC is “00:0d:02:be:4a:92”; and DS-1F is “i0.” This means that “receiving a multicast data packet having a destination source of ‘192.168.0.1’ and a multicast group ID of ‘239.192.0.1’, the WMMR 301 rewrites the packet transmission destination MAC address to ‘00:0d:02:be:4a:92’ and sends the packet via the interface i0.”

FIG. 4 is an illustration showing management information (entry) of a source gateway table. As shown in FIG. 4, the SGWT 20 has an entry form (SGWIS, SID, GID, LHR-Conn). Here, the SGWID is the ID of an SGW. The SID is a multicast data packet distribution source ID. The GID is a multicast group ID.

The LHR-Conn is a value indicating whether the SGW is connected to an LHR (last hop router) (namely an L-SGW) or not (namely an S-SGW). The LHR-Conn denotes “Connected” if connected and otherwise “Not-Connected.”

Instead of a multicast data packet distribution source ID, “All ID” denoting all IDs can be registered in the SID. Furthermore, instead of a group ID to which multicast data packets are distributed, “All ID” denoting all IDs can be registered in the GID.

For example, it is assumed that the SGWID is “192.168.101.101”, the SID is “192.168.0.1”, the GID is “239.192.0.1”, and the LHR-Conn is “Connected.” This means that “the SGW in charge of multicast data packets having a multicast data packet distribution source of ‘192.168.0.1’ and a multicast group ID of ‘239.192.0.1’ is ‘192.168.101.101’ and this SGW is connected to an LHR, namely an L-SGW.”

The WMMRs 302, 303, and 304 have the same configuration as shown in FIG. 2.

Operation of the communication system according to this embodiment will be described hereafter.

(Establishment of new multicast data packet transfer route)

Operation for establishing a new multicast data packet transfer route will be described. In this embodiment, a general method using the IGMP Version 3 described in the following literature is used in order for a receiving terminal to join or withdraw from a multicast group.

(7) Internet Group Management Protocol, Version 3, RFC 3376.

The IGMP Version 3 is compatible with Versions 1 and 2. Therefore, the multicast data packet transfer route establishing method according to this embodiment is applicable to receiving terminals in which the Version 1 or 2 is installed.

In this method, the WMMR 301 is registered as the L-SGW at the SGWT 20 of all WMMRs 301 to 304. More specifically, an entry (WMMR 301, All ID, All ID, Connected) is registered at the SGWT 20 of all WMMRs 301 to 304.

First, a process for the receiving terminal 401 to join a group having the server 101 as the multicast data packet distribution source and a multicast group GID under the condition that no other receiving terminal is connected to the wireless multihop network 309 shown in FIG. 1 to join the multicast (initial registration process) will be described.

FIG. 5 is an illustration showing the transfer sequence of route control packets for establishing/deleting a multicast data transfer route. As shown in FIG. 5, the receiving terminal 401 sends to the WMMR 303 or an RGW an IGMP-Report 501 containing information such as a distribution source SID (the IP address of the server 101) and a multicast group GID.

FIG. 6 is a process flowchart of a WMMR receiving an IGMP-Report. The following explanation will be made with reference to this figure.

First, the process at the WMMR 303 receiving the IGMP-Report 501 will be described. As shown in FIG. 6, the recipient management unit N04 of the WMMR 303 or an RGW receives the IGMP-Report 501 via the interface i0, namely the physical interface N01-1 and communication control unit N02-1 (Step S601).

Subsequently, the route control unit N03 of the WMMR 303 acquires information such as a distribution source SID and a multicast group GID contained in the received IGMP-Report 501 (Step S602). Using the acquired information, the route control unit N03 registers an entry (SID, GID, Policy=“ACCEPT”, MAC-address corresponding to GID, i0) at the MRT 10 to update the MRT 10 (Step S603).

Here, the “MAC address corresponding to GID” will additionally be explained. When an IP address is used as a GID, the first 25 bits of the “MAC address corresponding to GID” are created by a hexadecimal number “01005E” followed by a bit “0.” The last 23 bits are the last 23 bits of a GID. For example, the MAC address corresponding to a GID “239.192.0.1” is “01:00:5E:40:00:01.”

Then, the route control unit N03 determines whether the MRT 10 is changed in the entry (SID, GID, Policy) before and after the registration of update (Step S604). Here, since a new entry is created in the MRT 10, the determination assumes change (Step S604; Yes), proceeding to Step S605.

Then, the route control unit N03 makes reference to the SGWT 20 and searches for an SGW in charge of the (SID, GID) that is subjected to change (Step S605). Here, the WMMR 301 is acquired as the SGW.

Subsequently, the route control unit N03 determines whether the acquired SGW is its own self (Step S606). Since the SGW is not its own self (Step S606; No), the route control unit N03 makes reference to the unicast routing table (not shown) of its own node and searches for the next hop on the route to the SGW (Step S607). Here, the WMMR 302 is acquired as the next hop. After the WMMR 302 is acquired, the route control unit N03 unicasts a WRM-Report 502 (see FIG. 5) containing information on difference (information on difference before and after update) in the MRT 10 to the WMMR 302 from the interface i1 (Step S608).

FIG. 7 is an illustration showing the data format of a WRM-Report. The WRM-Report 502 for adding an entry includes, as shown in FIG. 7, a field WRM-Type containing a description “0×12” indicating that this is a Report among the packet fields. Furthermore, a field Update-Type contains a description “0×02” indicating that this is difference. A field numof (S, G) contains a number “1” indicating the number of (SID, GID) described in the packet. A field Modify contains a description “0×02” indicating that this is addition. A field DS-MAC [1] contains the MAC address of an interface to send the WRM-Report. A field SID contains the ID of a multicast data packet distribution source desired to receive from. A field GID contains the ID of a multicast group desired to receive from.

Receiving the WRM-Report 502, the WMMR 302 adds the entry based on the contents of the WRM-Report 502 and sends a WRM-Report 503 to the WMMR 301.

FIG. 8 is a process flowchart of a WMMR receiving a WRM-Report. The process at the WMMR 302 receiving the WRM-Report 502 will be described with reference to this figure. As shown in FIG. 8, the recipient management unit N04 of the WMMR 302 receives a WRM-Report via the interface i2 (Step S701). Subsequently, the route control unit N03 of the WMMR 302 acquires the multicast data packet distribution source SID, multicast group GID, and MAC address of an interface to send a WRM-Report in the received WRM-Report 502 (Step S702).

Using the acquired information, the route control unit N03 registers at the MRT 10 an entry (SID, GID, Policy=“ACCEPT”, MAC address of the interface having sent the WRM-Report, interface having sent the WRM-Report) to update the MRT 10 (Step S703).

Subsequently, the route control unit N03 determines whether the MRT 10 is changed in the entry (SID, GID, Policy) before and after the registration of update (Step S704). Here, since a new entry is created in the MRT 10 and therefore the determination assumes change (Step S704; Yes).

Subsequently, the route control unit N03 makes reference to the SGWT 20 and searches for an SGW in charge of the (SID, GID) of the difference (Step S705). Here, the WMMR 301 is acquired as the SGW.

Subsequently, the route control unit N03 determines whether the acquired SGW is its own self (Step S706). Since the SGW is not its own self (Step S706; No), the route control unit N03 makes reference to the unicast routing table (not shown) of its own node and searches for the next hop on the route to the SGW (Step S707). Here, the WMMR 301 is acquired as the next hop. Subsequently, the route control unit N03 unicasts a WRM-Report 503 (see FIG. 5) containing information on difference (information on difference before and after update) in the MRT 10 to the acquired WMMR 301 (Step S708).

Receiving the WRM-Report 503, the WMMR 301 adds the entry based on the contents of the received packet and sends an IGMP-Report 504 to the MR 203.

The WMMR 301 receiving the WRM-Report 503 performs the same process as shown in FIG. 8. In other words, the recipient management unit N04 receives the WRM-Report via the interface i1 (Step S701), and the route control unit N03 acquires the multicast sender SID, multicast group GID, and DS-MAC contained in the received WRM-Report (Step S702) and registers the entry at the MRT 10 based on the acquired information (Step S703).

Subsequently, upon determination as to change in (SID, GID, Policy), the determination assumes change (Step S704; Yes), the route control unit N03 makes reference to the SGWT 20 and searches for an SGW in charge of the (SID, GID) that is subjected to change (Step S705). Here, the WMMR 301 is acquired as the SGW.

Subsequently, it is determined whether the acquired SGW is its own self (Step S706). Here, since the determination turns out to be affirmative (Step S706; Yes), the route control unit N03 determines whether its own self is connected to an LHR (namely an L-SGW) or not (namely an S-SGW) (Step S711). Since the WMMR 301 is connected to an LHR (namely an L-SGW), the determination turns out to be affirmative (Step S711; Yes), proceeding to Step S712.

The route control unit N03 sends an IGMP-Report 504 (see FIG. 5) for joining the multicast sender SID and multicast GID via the interface i0 connected to the MR 203 (LHR) based on the latest MRT 10 (Step S712).

Receiving the IGMP-Report 504, the MR (LHR) 203 will transfer multicast data packets of the SID and GID to the WMMR 301 ever since.

Through the above process, a multicast data packet transfer route is established in the wireless multihop network 309. FIG. 9 is an illustration showing the registered entries of the multicast routing tables of the WMMRs. More specifically, the entries of the MRT 10 as shown in FIG. 9 are registered at the WMMRs 301, 302, and 303. Here, the notation “MAC (N)” indicates the MAC address of a node N. The same notation will be used hereafter in the same meaning.

(Additional registration of receiving terminal)

Additional registration of a receiving terminal will be described hereafter. FIG. 10 is a chart showing the transfer sequence of a route control packet for additionally registering/deleting a receiving terminal.

A process for a receiving terminal 402 to join the multicast group having the server 101 as the distribution source under the condition that only the receiving terminal 401 has joined the multicast group GID having the distribution source SID through the above-described initial registration process (additional registration process) will be described with reference to FIG. 10.

The receiving terminal 402 sends an IGMP-Report 901 containing a distribution source SID and a multicast group GID desired to receive from.

As shown in FIG. 6, the recipient management unit N04 of the WMMR 302 or an RGW receives the IGMP-Report from the physical interface i0 (Step S601). Subsequently, the route control unit N03 of the WMMR 302 acquires the multicast sender SID and multicast group GID contained in the received IGMP-Report (Step S602). Subsequently, the route control unit N03 resisters at the MRT 10 an entry (SID, GID, Policy=“ACCEPT”, MAC address corresponding to GID, interface) based on the acquired information to update the MRT 10 (Step S603). Then, the route control unit N03 determines whether there is any change in (SID, GID, Policy) before and after the registration of update (Step S604). Here, since the entry is registered before this registration, there is no change and the determination turns out to be negative (Step S604; No), whereby the process ends.

Through the above process, a multicast data packet transfer route for the additionally registered receiving terminal 402 is established. FIG. 11 is an illustration showing the entries of the multicast routing tables of the WMMRs after the additional registration. More specifically, the entry of the MRT 10 shown in FIG. 11 is additionally registered at the WMMR 302. As shown in FIG. 11, “multicast” is registered in the field DS-MAC of the entry of the MRT 10 of the WMMR 302. This means that the WMMR 302 performs broadcasting to the receiving terminal 402.

(Withdrawal of receiving terminal)

Withdrawal of a receiving terminal will be described hereafter.

A process for first the receiving terminal 402 and then the receiving terminal 401 to withdraw under the condition that the receiving terminals 401 and 402 have joined the distribution source SID and multicast group GID through the above-described initial registration process in FIG. 1 (deletion process) will be described hereafter.

The receiving terminal 402 sends an IGMP-Report 901 containing a multicast sender SID and a multicast group GID desired to withdraw from (see FIG. 10). As shown in FIG. 6, the recipient management unit N04 of the WMMR 302 or an RGW receives the IGMP-Report 901 via the interface i0 (Step S601). Subsequently, the WMMR 302 acquires the distribution source SID and multicast group GID contained in the received IGMP-Report 901 (Step S602).

Subsequently, using the acquired information, the route control unit N03 searches for the entry of the MRT 10 to delete and deletes the entry (SID, GID, Policy=“ACCEPT”, MAC address corresponding to GID, i0) from the MRT 10 to update the MRT 10 (Step S603).

Subsequently, the route control unit N03 determines whether there is any change in (SID, GID, Policy) before and after the registration of update (Step S604). Here, the entry (SID, GID, Policy) is still maintained as shown in FIG. 11, the route control unit N03 determines that there is no difference before and after the registration (Step S605; No) and ends the process.

Through the above process, the receiving terminal 402 is withdrawn.

Then, the receiving terminal 401 sends an IGMP-Report 501 containing a multicast sender SID and a multicast group GID desired to withdraw from (see FIG. 5).

The recipient management unit N04 of the WMMR 303 or an RGW receives the IGMP-Report 501 via the interface i0 (Step S601). Subsequently, the route control unit N03 acquires the distribution source SID and multicast group GID contained in the received IGMP-Report 501 (Step S602).

Subsequently, using the acquired information, the route control unit N03 searches for the entry of the MRT 10 to delete and deletes the entry (SID, GID, Policy=“ACCEPT,” MAC address corresponding to GID, i0) from the MRT 10 to update the MRT 10 (Step S603).

Then, the recipient management unit N04 determines whether there is any change in (SID, GID, Policy) before and after the registration of update (Step S604). Here, since the entry (SID, GID, Policy) is deleted from the MRT 10 of the WMMR 303, it is determined that there is change before and after the registration (Step S604; Yes).

Subsequently, the route control unit N03 makes reference to the SGWT 20 and searches for an SGW in charge of the (SID, GID) that is subjected to change (Step S605). Here, an SGW to be acquired is the WMMR 301. Since the acquired SGW is not its own self (Step S606; No), the route control unit N03 makes reference to the unicast routing table of its own node and searches for the next hop on the route to the SGW (Step S607). Here, the WMMR 302 is acquired. Subsequently, the route control unit N03 unicasts a WRM-Report 502 (see FIG. 5) containing information on difference in the MRT 10 to the WMMR 302 (Step S608).

FIG. 12 is an illustration showing the packet fields of a WRM-Report for deleting an entry. As shown in FIG. 12, a field WRM-Type contains a description “0×12” indicating that this is a Report. Furthermore, a field Update-Type contains a description “0×02” indicating that this is difference. A field numof (S, G) contains a number “1” indicating the number of (S, G) contained in this packet. A field Modify contains a description “0×03” indicating that this is for deletion. A field DS-MAC [1] contains the MAC address (MAC (WMMR 303)) of an interface to send the WRM-Report. A field SID contains the ID of a distribution source desired to delete. A field GID contains the ID of a multicast group desired to delete.

As shown in FIG. 8, the recipient management unit N04 of the WMMR 302 receives the WRM-Report 502 at the interface i2 (Step S701). Subsequently, the route control unit N03 of the WMMR 302 acquires the distribution source SID, multicast group GID, and DS-MAC contained in the received WRM-Report 502 (Step S702). Subsequently, using the acquired information, the route control unit N03 searches for the entry of the MRT 10 to delete and deletes the entry (SID, GID, Policy=“ACCEPT”, DS-MAC, i2) from the MRT 10 to update the MRT 10 (Step S703).

Then, the route control unit N03 determines whether there is any change in the entry (SID, GID, Policy) before and after the registration of update (Step S704). Here, since the entry (SID, GID) is deleted from the MRT 10 of the WMMR 302, it is determined that there is change before and after the registration (Step S704; Yes).

Then, the route control unit N03 makes reference to the SGWT 20 and searches for an SGW in charge of the (SID, GID) of the difference (Step S705). Here, the WMMR 301 is acquired as the SGW.

Subsequently, if the acquired SGW is not its own self (Step S706; No), the route control unit N03 makes reference to the unicast routing table of its own node and searches for the next hop on the route to the SGW and acquires the WMMR 301 (Step S707). Then, the route control unit N03 unicasts a WRM-Report 503 (see FIG. 5) containing information on difference in the MRT 10 to the WMMR 301 (Step S708).

In the network configuration of FIG. 1, the above process leads the WRM-Report 503 to an SGW (WMMR 301). When the number of hops is larger, the steps S701 to 708 are repeated at the adjacent nodes in the direction to the SGW and the WRM-Report finally reaches the SGW.

As shown in FIG. 8, the recipient management unit N04 of the WMMR 301 receives the WRM-Report 503 via the interface i1 (Step S701). Subsequently, the route control unit N03 of the WMMR 301 acquires the distribution source SID, multicast group GID, and DS-MAC contained in the received WRM-Report 503 (Step S702).

Subsequently, using the acquired information, the route control unit N03 searches for the entry of the MRT 10 to delete and deletes the entry (SID, GID, Policy=“ACCEPT”, DS-MAC, i1) from the MRT 10 to update the MRT 10 (Step S703).

Subsequently, the route control unit N03 determines whether there is any change in (SID, GID, Policy) before and after the registration of update (Step S704). Here, since the entry in question is deleted from the MRT 10 of the WMMR 301, it is determined that there is change before and after the registration (Step S704; Yes). Then, the route control unit N03 makes reference to the SGWT 20 and searches for an SGW in charge of the (SID, GID) of the difference (Step S705). Here, the WMMR 301 is acquired as the SGW.

Subsequently, since the acquired SGW is its own self (Step 5706; Yes), the route control unit N03 determines whether its own self is connected to an LHR (namely an L-SGW) or not (namely an S-SGW) (Step S711). Since the WMMR 301 is connected to the MR (LHR) 202 and is an L-SGW, the determination turns out to be affirmative (Step S711; Yes), whereby the route control unit N03 sends an IGMP-Report 504 (see FIG. 5) indicating withdrawal to the distribution source SID and multicast GID via the interface connected to the LHR based on the latest MRT 10 (Step S712). Receiving the IGMP-Report, the MR (LHR) 203 will no longer transfer multicast data packets of the SID and GID to the WMMR 301.

Through the above process, a multicast data packet transfer route is deleted.

The IGMP Version 3 has a source-filtering function that allows for detailed reception control such as “joining a multicast of the multicast group GID from a sender other than the distribution source SID.” Also in this embodiment, control equivalent to the IGMP Version 3 can be realized by a combination of Policy setting (ACCEPT/DROP) and SID setting “All ID.”

(Maintenance of multicast data packet transfer route)

A method of maintaining a multicast data packet transfer route will be described in detail hereafter.

All WMMRs 301 to 304 periodically send a WRM-Report containing all entries of the MRT 10 to the adjacent node in the direction to the SGW corresponding to each entry. Receiving a WRM-Report, the WMMRs 301 to 304 compare the entry contained therein with their own MRT and, when a new entry is found, send a WRM-Report containing only that entry to the adjacent node in the direction to the corresponding SGW. The node receiving the WRM-Report updates its own MRT 10 based on the received WRM-Report and, if there is any change (difference) in the MRT 10, further sends a WRM-Report to the adjacent node in the direction to the SGW.

With the above process being repeated, the WRM-Report finally reaches the SGW. In this way, a multicast data packet transfer route is maintained.

In the event that a multicast data packet distribution source or WMMR disappears without sending a withdrawal message, the maintenance process is not performed for that node and the corresponding entries of the MRT 10 are deleted after a specific time period.

FIG. 13 is an illustration showing the packet fields of a WRM-Report for maintaining an entry. As shown in FIG. 13, a field WRM-Type contains a description “0×12” indicating that this is a Report. Furthermore, a field Update-Type contains a description “0×01” indicating that this is for the entire entry. A field numof (S, G) contains a number “1” indicating the number of (S, G) contained in this packet. A field Modify contains a description “0×01” indicating “no change.” A field DS-MAC [1] contains the MAC address of an interface to send the WRM-Report. A field SID contains the multicast data packet distribution source ID of the entry to maintain. A field GID contains the multicast group ID of the entry to maintain.

(Multicast data packet transfer operation)

Multicast data packet transfer operation will be described hereafter. Here, the multicast data packet transfer process involving the receiving terminals 401 and 402 will be described in detail.

After a series of multicast data packet transfer route establishing processes in the wireless mesh network 309 are completed and the WMMR 301 sends the IGMP-Report 504 (see FIG. 5) to the LHR as described above, a multicast route is established from the server 101 to the LHR in the backbone multicast network 209. Then, the server 101 sends a multicast data packet addressed to the multicast group GID and the multicast data packet is transferred through the backbone multicast network 209 and sent to the WMMR 301 via the MR (LHR).

FIG. 14 is a process flowchart of the multicast data packet transfer operation. As shown in FIG. 14, the transfer control unit N05 of the WMMR 301 receives a multicast data packet via the interface i0, namely the physical interface N01 and communication control unit N02 (Step S 1401).

Subsequently, the transfer control unit N05 makes reference to the data cache N06 (Step S 1402) and determines whether the same packet is already received (Step S1403). Here, if the packet is received for the first time (Step S1403; No), the transfer control unit N05 registers information on the packet at the data cache (Step S1404) , searches for the entry (SID, GID) of the MRT 10, and acquires the entry of the transfer destination (Step S1405). Here, the entry (SID, GID, Policy=“ACCEPT”, DS-MAC=“MAC (302)”, i1) is acquired.

Subsequently, when there are multiple transfer destinations, the transfer control unit N05 makes copies of the multicast data packet (Step S1406), changes the transmission source MAC address of the multicast data packet to its own MAC address and the destination MAC address to MAC (302) (Step S1407), and sends it from the interface i1 (Step S1408).

On the other hand, if the same multicast data packet is already received (Step S1403; Yes), the transfer control unit N05 disposes the packet (Step S1410) and ends the process.

In this embodiment, the same process is preformed at the WMMRs 302 and 303.

Through the above process, a multicast data packet distributed by the server 101 and coming in via the backbone multicast network 209 and MR 203 (LHR) is delivered to the receiving terminals 401 and 402.

### Embodiment 2

Embodiment 2 of the present invention will be described hereafter.

FIG. 15 is an illustration showing the node allocation of a wireless network system configuration according to Embodiment 2. As shown in FIG. 15, a wireless multihop network 309 constituted by WMMRs 301 to 304 is connected to a server 102 distributing multicast data packets and receiving terminals 401 and 402. In other words, the multicast data packet distribution source server 102 is directly connected to the wireless multihop network 309. Furthermore, the WMMRs 302 and 303 are RGWs.

In this embodiment, the WMMR 301 is an S-SGW. The others are the same as those in Embodiment 1. In this embodiment, the WMMRs 302, 303, and 304, which are not an SGW, operate as in Embodiment 1. In this embodiment, the WMMR 301 is registered at the SGWT 20 of all WMMRs 301 to 304 as the S-SGW. More specifically, the entry (WMMR 301, All ID, All ID, NOT-Connected) is present at the SGWT 20 of all WMMRs.

The WMMR 301 or an SGW receives an IGMP-Report or WRM-Report from an adjacent node (Step S601 in FIG. 6 or Step S701 in FIG. 8), acquires information from the packet, and registers or deletes the entry of the MRT 10 to update MRT 10 (Steps S602 and S603 in FIG. 6 and Steps S702 and S703 in FIG. 8).

If there is any change in the MRT 10 (Step S604 in FIG. 6 or Step S704 in FIG. 8; Yes) and its own self is an SGW in charge of the (SID, GID) of the difference in the MRT (Step S606 in FIG. 6 or Step S706 in FIG. 8; Yes), the route control unit N03 determines whether its own self is an L-SGW (Step S611 in FIG. 6 or Step S711 in FIG. 8). Since the WMMR 301 is an S-SGW, the determination turns out to be negative (Step S611 in FIG. 6 or Step S711 in FIG. 8; No), the process ends.

In other words, when the SGW is directly connected to the distribution source, the SGW does not send an IGMP-Report.

### Embodiment 3

Embodiment 3 of the present invention will be described hereafter. The network configuration according to this embodiment is the same as the one in Embodiment 1 (see FIG. 1). In this embodiment, registration at the SGWT 20 of all WMMRs 301 to 304 is automatically done.

(Setting and notification of L-SGW)

First, a method of setting an L-SGW and a method of notifying all WMMRs of the setting content will be described with reference to FIG. 1. In FIG. 1, the MR 203 that is the LHR of a backbone multicast network periodically sends an IGMP-Query packet via the interface i0.

Receiving the IGMP-Query packet, the WMMR 301 registers its own self as an L-SGW at the SGWT 20. More specifically, the route control unit N03 of the WMMR 301 registers the entry (WMMR 301, All ID, All ID, Connected) at the SGWT 20.

While having this entry, the route control unit N03 of the WMMR 301 floods a WRM-SGWAD packet throughout the wireless multihop network 309.

FIG. 16 is an illustration showing the packet fields of a WRM-SGWAD packet. As shown in FIG. 16, a field WRM-Type contains a description “0×11” indicating SG-WAD. Furthermore, a field numof (S, G) contains a number “1” indicating the number of (SID, GID) contained in this packet. A field SGWID contains the SGW ID. A field SID contains the ID of the distribution source the SGW is in charge of. A field GID contains the ID of the multicast group the SGW is in charge of. Here, the fields SID and GID each contain “All ID” indicating all IDs. A field LHR-Conn contains a description “Connected” indicating an L-SGW.

The flooding method can be a method utilizing, for example, a conventional SMF protocol. The SMF protocol is explained in detail in the following literature. SMF: Simplified Multicast Forwarding for MANET, draft-ierf-manet-smf-08.

Receiving the WRM-SGWAD packet sent by the WMMR 301, all WMMRs 301 to 304 add the entry to their own SGWT 20 based on information contained in the WRM-SGWAD packet.

(Setting and notification of S-SGW)

First, a method of setting an S-SGW and a method of notifying all WMMRs of the setting content will be described with reference to FIG. 15.

As shown in FIG. 15, the server 102 sends to the WMMR 301 a packet specific to a multicast data packet distribution source. “A packet specific to a distribution source” can be a packet sent only by a multicast data packet distribution source or a packet sent by other nodes with no distribution source ID. As “a packet specific to a distribution source,” for example, an RTCP Sender Report, a multicast data packet, a packet specific to a multicast application can be used.

Receiving the packet specific to a distribution source, the WMMR 301 registers its own self as an S-SGW at its own SGWT 20. More specifically, the route management unit N07 of the WMMR 301 registers the entry (WMMR 301, All ID, All ID, Not-Connected) at the SGWT 20.

While having this entry, the WMMR 301 floods a WRM-SGWAD packet throughout the wireless multihop network 309.

Here, the field LHR-Conn of a WRM-SGWAD contains a description “Not-Connected” indicating that it is an S-SGW. The other fields have the same contents as in the above case of an L-SGW.

(Maintenance of SGW)

While the MR 302 and WMMR 301 are connected, the MR 203 periodically sends an IGMP-Query packet from the interface i0 and the WMMR 301 receives the IGMP-Query packet. In this state, the WMMR 301 or an SGW periodically floods a WRM-SGWAD packet.

The WMMRs receiving the WRM-SGWAD packet add the entry to the SGWT 20 of their own node based on information contained in the WRM-SGWAD packet. If the same entry is already present at the SGWT 20, the WMMR does nothing. The entry at the SGWT 20 of all WMMRs is maintained as long as a WRM-SGWAD packet is periodically received.

When MR (LHR) 203 and WMMR 301 are disconnected and a given time period elapses, the WMMR 301 deletes the entry at the SGWT 20 and stops sending a WRM-SGWAD packet. The other WMMRs delete the entry at their own SGWT 20 after they have received no WRM-SGWAD packet for a given time period.

Through the above process, the entry is registered and maintained at the SGWT 20 of all WMMRs. While the entry is registered at the SGWT 20 of all WMMRs, the process to establish a multicast data transfer route and process to transfer a multicast data packet according to the above Embodiment 1 can be performed.

### Embodiment 4

Embodiment 4 of the present invention will be described hereafter.

In this embodiment, a combination of unicasting and broadcasting is used in the data link layer of data communication between a RGW and a receiving terminal.

In the above embodiments, a multicast packet is sent from an RGW to a receiving terminal using broadcasting in the data link layer. In this way, the receiving terminal does not need to have an additional special function. However, in such a case, there is a risk of packet loss between the RGW and receiving terminal.

Then, in this embodiment, a combination of unicasting and broadcasting in the data link layer is used also for transmission from an RGW to a receiving terminal. In order to realize unicasting in the data link layer, the receiving terminal has to have a function of recognizing that a packet having a destination IP address of multicast and a destination MAC address of unicast is addressed to its own self.

(Method of establishing multicast data packet transfer route)

The method of establishing a multicast data packet transfer route is different from that of the above embodiments only in the procedure upon an RGW receiving an IGMP-Report from a receiving terminal.

FIG. 17 is an illustration showing the node allocation of a network system configuration according to Embodiment 4 of the present invention. As shown in FIG. 17, a multicast network 1401 includes one or more multicast data packet distribution sources. A wireless multihop network 309 comprises WMMRs 301 to 306. Here, the multicast network 1401 can include a network such as a backbone multicast network 209 in FIG. 1 or consists of a distribution source server only as shown in FIG. 15.

Through the same procedure as in Embodiment 1, the receiving terminal 401 sends an IGMP-Report containing a multicast sender SID and a multicast group GID desired to receive from. The WMMR 301 or an RGW receives the IGMP-Report at the interface i0.

As shown in FIG. 6, the recipient management unit N04 of the WMMR 301 receives the IGMP-Report at the interface i0 (Step S601). Subsequently, the route control unit N03 acquires the multicast data packet distribution source SID and multicast group GID contained in the received IGMP-Report (Step S602).

Here, the route control unit N03 acquires the MAC address of the IGMP-Report transmission source. The MAC address is equal to the MAC address of the receiving terminal 401. Using the acquired information, the route control unit N03 registers at the MRT 10 an entry (SID, GID, Policy =“ACCEPT”, MAC (401), i0) to update the MRT 10 (Step S603). Following this, the procedure to register or delete the MRT 10 and the procedure to send a WRM-Report are performed as in Embodiment 1.

Similarly, in regard to the receiving terminals 402, 403, 404, and 405, the above process is performed at the WMMRs 305 and 306 or RGWs. FIG. 18 is an illustration showing the registered entries of the multicast routing tables of the WMMRs in the network system in FIG. 17. Consequently, the WMMRs 303, 305, and 306 have the entries at their MRTs 10 as shown in FIG. 18.

The entries of the MRTs 10 of the other WMMRs are registered in the same manner as in Embodiment 1.

(Multicast data packet transfer operation)

When a multicast data packet distribution source in the multicast network 1401 sends a multicast data packet, the packet is received by the WMMR 301 via the multicast network 1401. The WMMR 301 sends the multicast data packet to the WMMR 302 in the same manner as in Embodiment 1. The WMMR 302 unicasts the multicast data packet to the WMMRs 303, 305, and 306, respectively.

FIG. 19 is a process flowchart of the multicast data packet transfer operation in the network system in FIG. 17. As shown in FIG. 19, receiving a multicast data packet having a multicast data packet distribution source SID and a multicast group GID at the interface i1 (Step S1901), the transfer control unit N05 of the WMMR 303 makes reference to the data cache N06 (Step S1902) and determines whether the same packet is already received (Step S1903).

Here, if the multicast data packet is received for the first time (Step S1903; No), the transfer control unit N05 registers information on the packet at the data cache (Step S1904), searches for an MRT 10 having (SID, GID), and acquires the transfer destination MAC address and transfer interface (DS-MAC=MAC (401), i0) (Step S1905).

Then, the transfer control unit N05 determines the transmission method in the data link layer (Step S1906). Here, the transmission method in the data link layer can be determined by, for example, the following methods.

(Method 1): If the number of transmission destination nodes is larger than a predetermined threshold of the number of downstream adjacent nodes, broadcasting is used; otherwise, unicasting is used.

(Method 2): The wireless band occupancy time in the case of unicasting and the wireless band occupancy time in the case of broadcasting are calculated and the transmission method with a smaller value is used.

Furthermore, unicasting or broadcasting can be selected depending on the receiving terminal. Such methods include the following.

(Method 3): Unicasting is used for receiving terminals connected by a link with a packet loss rate higher than a predetermined packet loss rate threshold; broadcasting is used for the other receiving terminals.

(Method 4): Broadcasting is used for receiving terminals connected by a link with a delay larger than a predetermined delay threshold; unicasting is used for the other receiving terminals.

The method of determining the transmission method in the data link layer is not restricted to the above methods. Furthermore, a proper combination of the following methods can also be used. More specifically, for example, using (Method 1) in which “a predetermined threshold of the number of downstream adjacent nodes” is 2, the WMMR 303 has one downstream adjacent node and therefore unicasts multicast data packets. With the same process applying, the WMMR 305 utilizes unicasting. The WMMR 306 has three downstream adjacent nodes and utilizes broadcasting.

Then, the transfer control unit N05 makes as many copies of the multicast data packet as the number of transfer destinations (Step S1907) and performs the following process for each destination (Steps S1908 to S1913).

If unicasting is used for transmission to the destination in the data link layer (Step S1909; Yes), the transfer control unit N05 updates the multicast data packet transmission source MAC address to its own MAC address, updates the destination MAC address to MAC (401), and performs transmission from the interface i0 (Step S1915).

FIG. 20 shows a completed broadcasting list. If broadcasting, not unicasting, is used for transmission to the destination in the data link layer (Step S1909; No), reference is made to the completed broadcasting list 30 and it is determined whether broadcasting to the interface intended for transmission is already completed (Step S1910). If it is not completed (Step S1910; No), the transfer control unit N05 updates the multicast data packet transmission source MAC address to its own MAC address, updates the destination MAC address to the MAC address corresponding to the GID, and performs transmission from the interface i0 (Step S 1911). Subsequently, the transfer control unit N05 registers at the completed broadcasting list 30 in FIG. 20 (Step S1912).

If broadcasting to the interface intended for transmission is already completed (Step S1910; Yes), the transfer control unit N05 disposes the packet (Step S1914).

On the other hand, if the same packet is already received (Step S1903), the transfer control unit N05 disposes the received packet (Step S1916) as in the above embodiments.

### Embodiment 5

Embodiment 5 of the present invention will be described hereafter. In this embodiment, a combination of unicasting and broadcasting is used in the data link layer for data communication between WMMRs.

When a WMMR has many adjacent transfer destination nodes and is good in communication quality with them, broadcasting may provide communication with a higher distribution rate and smaller delay in some cases. In this embodiment, a combination of unicasting and broadcasting is used also in the data link layer for communication between WMMRs.

In this embodiment, the multicast data packet transfer route is established by the same method as in the above Embodiment 1.

In the multicast data packet transfer operation, unicasting or multicasting is selected by “a method of selecting unicasting or broadcasting in the data link layer” among (Method 1) to (Method 4) given in the above Embodiment 4 and transmission is performed by the selected method. For example, it is assumed that (Method 1) is used as the above method and the predetermined threshold of the number of downstream adjacent nodes is 2. In the network configuration shown in FIG. 17, unicasting is used for transmission from the WMMR 301 to the WMMR 302 and broadcasting is used for transmission from the WMMR 302 to the WMMRs 303, 305, and 306.

### Embodiment 6

Embodiment 6 of the present invention will be described hereafter. In this embodiment, the wireless mesh network 309 constitutes a VPN (Virtual Private Network).

There are two types of wireless mesh networks; a flat type in which a connected terminal and a base station have the same subnetwork address and a VPN type in which a terminal and a base station have different subnetwork addresses.

A flat type wireless mesh network can advantageously be realized by general IP packet transfer but disadvantageously requires the terminal user to be aware of the IP address system of the wireless mesh network. On the other hand, a VPN type wireless mesh network is disadvantageously not realized simply by general IF transfer because it requires a function to encapsulate and decapsulate packets for the terminal at the entrance/exit to/from the network; however, it advantageously allows the terminal to use a wireless mesh network without being aware of its internal structure.

The network according to the above embodiments is applicable both to a flat type wireless mesh network and to a VPN type wireless mesh network. In this embodiment, a method of setting an SGW in a VPN type wireless mesh network without using the fixed SGW setting in Embodiments 1 and 2 or WRM-SGWAD in Embodiment 2 is described.

The multicast data packet transfer according to this embodiment is performed on the following presumption.

(1) All WMMRs always manage the MAC addresses of terminals connected to them and notify all WMMRs of related information, whereby the correspondence between the terminals connected to the wireless mesh network and the WMMRs to which the terminals are connected is established at all WMMRs. This function is termed attribution management function and the correspondence to be managed here is termed attribution management information.

(2) The LHR has a Proxy-ARP function to return its own MAC address in response to an ARP-Request addressed to a terminal of a network other than the wireless mesh.

(Stage of establishing multicast data packet transfer route)

In this embodiment, The LHR ID is set at each WMMR. The LHR is located in the backbone network and rarely subject to change. Furthermore, since the default gateway used by the receiving terminals for unicasting consists of the LHR in most cases, the interface ID of the LHR can be set in compliance with the setting of the default gateway of the receiving terminals. The LHR can be set at each WMMR, for example, by static setting or by acquiring the IP address of the default gateway described in a packet in the case wherein the receiving terminal sets the dynamic IP address with DHCP.

First, the receiving terminal 401 sends an IGMP-Report 2101 containing a multicast sender SID and multicast group GID desired to receive from. The WMMR 303 or an RGW receives the IGMP-Report at the interface i0. FIG. 22 is a process flowchart of a WMMR receiving a WRM-Report when a VPN network is formed. FIG. 22 shows the process flowchart of the WMMR 303.

As shown in FIG. 22, the Steps S2201 to S2205 and S2206 to S2212 are the same as Steps S601 to S605 and S606 to S612 in the establishment process of Embodiment 1 (see FIG. 6).

In FIG. 22, receiving the IGMP-Report (Step S2201), the route control unit N03 of the WMMR 303 acquires (join or withdrawal, SID, GID) in the IGMP-Report in the same procedure as in Embodiment 1 (Step S2202).

The route control unit N03 updates the MRT 10 using the SID and GID (Step S2203) and determines whether there is any change in (SID, GID, Policy) before and after the update (Step S2204). If there is any change (Step S2204; No), the route control unit N03 searches the SGWT 20 for an SGW in charge of the (SID, GID) that is subjected to change (Step S2205). If an SGW in charge is found (Step S2206; Yes), the same procedures as in Embodiment 1 are executed (S2206 to S2212).

FIG. 21 is an illustration showing the transfer sequence of route control packets when a VPN network is formed. If no SGW in charge is found in the SGWT (Step S2206; No), the route control unit N03 creates an ARP-Request 2102 for inquiring about the MAC address of the SID (see FIG. 21) (Step S2222), floods it in the VPN (Step S2223), and waits for a reply ARP-Reply.

The intra-VPN ARP-Request is processed by the wireless mesh network and general IP functions and more specifically as follows.

The intra-VPN ARP-Request is delivered to all WMMRs by flooding function.

More specifically, as shown in FIG. 21, the intra-VPN ARP-Request 2102 sent by the WMMR 303 is received by the WMMR 302. Then, the WMMR 302 sends an intra-VPN ARP-Request 2103, which is received by the WMMR 301. The WMMR 301 sends an ARP-Request 2104 to the terminal attributing to its own self. The MR 203, which is the inquiry destination of the ARP-Request 2104, returns an ARP-Reply 2105 in which its own MAC address is described to the WMMR 301 by unicasting. The WMMR 301 unicasts an ARP-Reply 2106 in the VPN. The WMMR 303 receives an ARP-Reply 2107 via the WMMR 302.

Through the above series of processes, after the WMMR 303 receives the intra-VPN ARP-Reply 2107, the route control unit N03 registers the transmission source ID (transmission 25 source IP address) at the SGWT as the SGW (Step S2224). Following this, the same procedures as in Embodiment 1 are executed (Steps S2207 to S2212). Consequently, as shown in FIG. 21, WRM-Reports 2108 and 2109 and an IGMP-Report 2110 are transferred to establish a multicast data packet transfer route.

As described above in detail, the wireless multihop network 309 according the above embodiments has the following effects.

(1) Unicasting capable of arrival confirmation and retransmission control on packets that have failed to arrive is used in the data link layer of a wireless network; therefore, in case of packet loss, the packet loss can be restored in the data link layer, whereby missing data at the application level can be reduced compared with use of multicasting in the data link layer.

For example, on a link with a packet loss rate of 0.1, a high packet arrival rate of 0.9999 =(1−0.1)⁴ is obtained in unicasting with up to 3 retransmission operations while it is 0.9 (=1−0.1) in multicast data packet transmission.

As described above, the above embodiments realize highly reliable and high throughput communication by using unicasting. This method is particularly suitable for audio and video image distribution.

(2) Use of high speed unicast transmission reduces the band occupancy time. For example, for transferring a 1000-byte packet in the data link layer under the wireless standard IEEE 802.11a, the band occupancy time is 1509.5 μsec in multicasting at a transfer rate of 6 10 Mbps. On the other hand, the band occupancy time is 321.5 μsec in unicasting at a transfer rate of 54 Mbps. In other words, the communication band occupancy time is reduced to approximately one third in unicasting compared with multicasting.

(3) An IGMP-Report sent by a multicast receiving terminal is converted to information on a WRM of the wireless mesh network and reconverted to an IGMP at the SGW of the wireless mesh network, whereby an IGMP Report can be sent to the LHR. Consequently, a multicast data packet transfer route can be established without providing a receiving terminal with any special function.

The WMMRs according to this embodiment can select unicasting or broadcasting in consideration of the quality of the data link layer, whereby communication with a low packet loss rate and high throughput is available.

In the above embodiments, an IGMP-Report and WRM-Report are used to establish a multicast data packet transfer route. A multicast data packet transfer route can be set at WMMRs in advance so that the route can be established without using a WRM-Report.

In the above embodiments, the IGMP protocol of IPv4 is used. Instead, the MLD protocol can be used where IPv6 is used as the network layer protocol. The MLD protocol is described in detail, for example, in the following literature.

Multicast Listener Discovery Version 2 (MLD v2) for IP v6, RFC 3810.

The present application claims the priority based on the Japanese Patent Application No. 2009-071048, of which the specification, scope of claims, and drawings are all incorporated herein by reference.

### Explanation of Symbols

10 multicast routing table (MRT)

20 source gateway table (SGWT)

30 completed broadcasting list

101, 102 server

201, 202, 203, 304, multicast router (MR)

209 backbone multicast network

301, 302, 303, 304, 305, 306 wireless multihop multicast router (WMMR)

309 wireless multihop network

401, 402, 403, 404, 405 receiving terminal

501, 504, 901, 2101, 2110, IGMP-Report

502, 503, 2108, 2109 WRM-Report

1401 multicast network

2102, 2103 intra-VPN ARP-Request

2104 ARP-Request

2105 ARP-Reply

2106, 2107 intra-VPN ARP- Reply

N01-1, N01-2, . . . physical interface

N02-1, N02-2, . . . communication control unit

N03 route control unit

N04 recipient management unit

N05 transfer control unit

N06 data cache

N07 route management unit

1. A wireless communication apparatus used as a wireless relay node in a wireless network connected to a backbone network including a multicast data packet distribution source, comprising:
a route control unit establishing a multicast data packet transfer route connecting said distribution source and a receiving terminal based on unicast routes; and
a transfer control unit making a transfer to a directly connected transfer destination along the established multicast data packet transfer route by unicasting capable of arrival confirmation and retransmission control as a transmission scheme in the data link layer.

2. The wireless communication apparatus according to claim 1, wherein said route control unit:
creates information regarding said transfer route based on a route control packet sent from the adjacent node downstream on said transfer route;
receives an IGMP-Report or WRM-Report as said route control packet; and
upon receiving said IGM-Report as said route control packet, sends a WRM-Report as said route control packet to the adjacent node upstream on said transfer route in said wireless network and an IGMP-Report as said route control packet to a node in a directly connected external network.

3. The wireless communication apparatus according to claim 2, wherein said transfer control unit:
can transfer said multicast data packet to a directly connected transfer destination by broadcasting incapable of arrival confirmation and retransmission control as a transmission scheme in the data link layer; and
selects whether to unicast or broadcast said multicast data packet based on at least one of the following: the number of nodes to which said multicast data packet is sent and the wireless band occupancy time required for transmitting said multicast data packet.

4. The wireless communication apparatus according to claim 2, wherein aid transfer control unit:
can transfer said multicast data packet to a directly connected transfer destination by broadcasting incapable of arrival confirmation and retransmission control as a transmission scheme in the data link layer; and
selects whether to unicast or broadcast said multicast data packet to each of the nodes to which said multicast data packet is sent based on at least one of the following: the packet loss rate and the transmission delay time of a packet sent to the node.

5. The wireless communication apparatus according to claim 4, wherein said route control unit:
floods a route maintenance packet for maintaining said transfer route throughout said wireless network at an arbitrary timing;
upon receiving said flooded route maintenance packet, updates information regarding said transfer route based on said route maintenance packet; and
deletes information regarding said transfer route that is not updated for a given time period.

6. The wireless communication apparatus according to claim 5, wherein said route control unit:
upon receiving a node designation packet for designating the most upstream node connected to a node in said backbone network, stores its own self as the most upstream node and floods said node designation packet throughout said wireless network; and
upon receiving said flooded node designation packet, registers said flooding node as the most upstream node.

7. The wireless communication apparatus according to claim 6, wherein when said wireless network forms a virtual private network, said transfer control unit:
floods a packet for inquiring about the MAC address of the most upstream node connected to a node in said backbone network within said virtual private network for adding said transfer route; and,
upon receiving the flooded inquiring packet, transfers said inquiring packet to the adjacent node and, if the address contained in a reply packet is of a node in said backbone network, returns a reply packet indicating that its own self is the most upstream packet to the flooding node.

8. A wireless network system having the wireless communication apparatus according to claim 1 as a wireless relay node.

9. A data transfer method for a wireless relay node in a wireless network connected to a backbone network including a multicast data packet distribution source, comprising:
a route control step of establishing a multicast data packet transfer route connecting said distribution source and a receiving terminal based on unicast routes; and
a transfer control step of making a transfer to a directly connected transfer destination along the established multicast data packet transfer route by unicasting capable of arrival confirmation and retransmission control as a transmission scheme in the data link layer.

10. A computer-readable recording medium on which recorded are programs used for controlling a wireless relay node in a wireless network connected to a backbone network including a multicast data packet distribution source, wherein said programs allow a computer to execute:
a route control procedure to establish a multicast data packet transfer route connecting said distribution source and a receiving terminal based on unicast routes; and
a transfer control procedure to make a transfer to a directly connected transfer destination along the established multicast data packet transfer route by unicasting capable of arrival confirmation and retransmission control as a transmission scheme in the data link layer.
